(19) United States
(12) Patent Application Publication
(10) Pub. No.: US 2025/0315713 A1
(43) Pub. Date: Oct. 9, 2025

(54) SYSTEM AND METHOD FOR MANAGING INFERENCE MODELS

(71) Applicant: Dell Products L.P., Round Rock, TX (US)

(72) Inventors: ANTHONY ELI JREIJ, Pflugerville, TX (US); TSEHSIN JASON LIU, Wellesley, MA (US); VINAY SAWAL, Fremont, CA (US); JAMES KENDALL SNYDER, Rockledge, FL (US); FATEMEH AZMANDIAN, Raynham, MA (US)

(21) Appl. No.: 18/625,517

(22) Filed: Apr. 3, 2024

(51) Int. Cl. G06N 20/00

(52) U.S. Cl. CPC G06N 20/00

(57) ABSTRACT

Methods and systems for managing inference models are disclosed. To manage inference models, an incomplete training dataset may be obtained. Additional data to complete the incomplete training dataset may then be obtained. To obtain the additional data, a plurality of imputation methods may be used. The complete training dataset may be used to obtain an inference model, which may be used to provide computer implemented services.

### FIELD

Embodiments disclosed herein relate generally to inference model management. More particularly, embodiments disclosed herein relate to systems and methods to manage training data used in obtaining inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 3 shows a flow diagram illustrating methods of managing operations of data processing systems in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to the methods and systems for managing inference models. To manage inference models, an inference model manager may obtain a dataset to be used as a training dataset. Once obtained, the inference model manager may determine the dataset to be incomplete.

Additional data may then be obtained to complete the incomplete dataset. To obtain the additional data, multiple imputation methods may be used concurrently to generate multiple imputed datasets. These imputed datasets may then be analyzed using any number of analysis methods to quantify the accuracy of the imputed data.

After analysis, the imputed datasets may be combined. To combine the datasets, a Bayesian modeling process may be used to generate a final imputed dataset as well as metrics that quantify a level of confidence in the imputed data.

The final imputed dataset may then be combined with the incomplete dataset to generate a complete dataset that may then be used as a training dataset to train an inference model.

Additionally, a root cause for the missing data in the incomplete dataset may be identified. The root cause may be identified by analyzing metrics obtained during the process of obtaining the additional data, imputation models used in obtaining the additional data may be ranked based on ascribed levels of accuracy, etc. For example, root causes may be associated with different imputation models, and the root cause associated with the imputation model ascribed the highest level of accuracy may be identified as the root cause for the incomplete training data.

Thus, embodiments disclosed herein may address, among other technical problems, the technical challenges of obtaining training datasets to train inference models. By generating multiple imputed datasets using multiple imputation algorithms to complete an incomplete training dataset, the final combined training dataset may be more accurate and thus more likely to generate an inference model capable of making accurate inferences.

In an embodiment, a method for managing inference models is disclosed. The method may include obtaining an incomplete training dataset; obtaining additional data to complete the incomplete training dataset to obtain a complete training dataset; obtaining an inference model using the complete training dataset; and providing computer implemented services using the inference model.

The additional data may be obtained using a plurality of imputation algorithms.

Obtaining the additional data may include obtaining a plurality of imputation results using the imputation algorithms; analyzing the plurality of imputation results to obtain a plurality of analysis results that are usable to guide a synthesis process through which the additional data may be obtained using the plurality of imputation results; and using the plurality of analysis results and the plurality of imputation results to obtain the additional data.

Using the plurality of analysis results and the plurality of imputation results may include combining the plurality of analysis results to obtain a joint result, where the joint result may include the additional data and the metrics that quantify a level of confidence in the additional data.

The method may also include identifying an inference model of a plurality of inference models used to obtain the additional data that was deemed to most accurately infer the additional data; and identifying, based on the identified inference model, a root cause for the incomplete training data set to exist.

The root cause may be used, in part, to provide the computer implemented services.

The incomplete training data set may specify a portion of a relationship, the additional data may specify a second portion of the relationship, and the complete training data may specify an entirety of the relationship.

The inference model may be trained to forecast the relationship outside of the domain defined by the complete training data.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

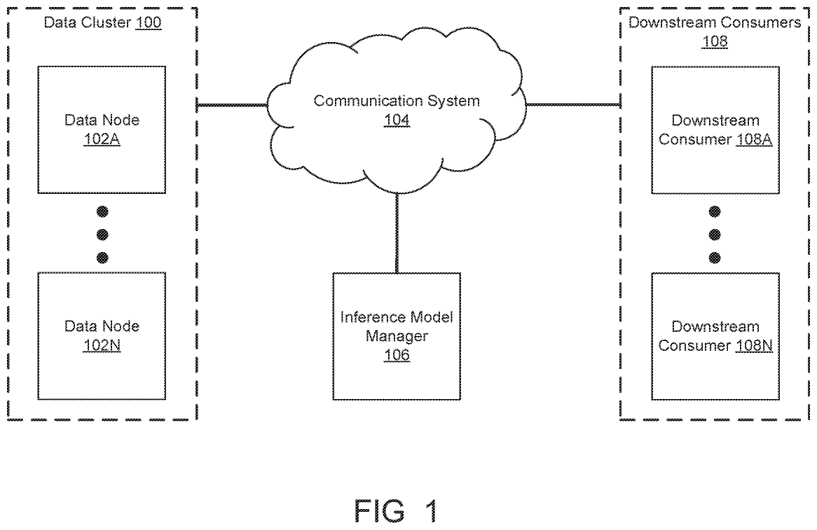

Turning to FIG. 1, a block diagram illustrating a system in accordance with an embodiment is shown. The system shown in FIG. 1 may provide computer-implemented services utilizing data stored in a data repository prior to performing the computer-implemented services. The computer-implemented services may include any type and quantity of computer-implemented services. For example, the computer-implemented services may include forecasting services, language processing services, and/or any other type of computer-implemented services.

To provide the computer-implemented services, the system may include data cluster 100 including data obtained from any number of data sources (not shown). Data cluster 100 may include any number of data nodes (e.g., 102A-102N). Each data node of data cluster 100 may provide similar and/or different computer-implemented services using the data.

For example, data cluster 100 may include data regarding central processing unit performance, disk utility, or memory usage. Data cluster 100 may include data node 102A including time series data from a sensor used to collect memory usage measurements from a computer.

Data cluster 100 may provide data to inference model manager 106. Inference model manager 106 may include any number of data processing systems including hardware and/or software components configured to facilitate performance of the computer-implemented services.

Inference model manager 106 may obtain data (e.g., from data cluster 100), process the data (e.g., fill data gaps, transform the data, extract values from the data, etc.) and/or may provide the data to other entities (e.g., downstream consumers 108) as part of facilitating the computer-implemented services.

Continuing with the above example, inference model manager 106 may obtain the memory usage measurements in data node 102A from data cluster 100. Inference model manager 106 may identify missing values in the data nodes and may fill them using any number of data imputation methods (e.g., linear interpolation, forward filling, etc.) and may analyze the data to assess the accuracy of the imputed values. Following data filling and analysis, inference model manager 106 may combine the filled data with the original data to create a complete training dataset.

Inference model manager 106 may provide the training dataset to downstream consumers 108. Downstream consumers 108 may utilize the training dataset to provide all, or a portion of, the computer-implemented services. Downstream consumers 108 may include any number of downstream consumers (e.g., 108A-108N). For example, downstream consumers 108 may include one downstream consumer (e.g., 108A) or multiple downstream consumers (e.g., 108A-108N) that may individually and/or cooperatively provide the computer-implemented services.

Continuing with the above example, downstream consumers 108 may utilize the complete training dataset from inference model manager 106 to train forecasting models. Specifically, downstream consumers 108 may utilize the complete training dataset to train a forecasting model to simulate future computer memory usage over time (e.g., to predict memory usage patterns, changes in memory usage, etc.).

To provide one or more of the computer-implemented services, the missing data in the training dataset utilized by downstream consumers 108 may need to be accurately filled. If the training dataset contains gaps in the data, and/or if the filled data is not accurate, then the downstream consumers 108 may be unable to provide all, or a portion, of the computer-implemented services that it normally provides.

In general, embodiments disclosed herein may provide methods, systems, and/or devices for improving the likelihood that data processing systems have access to inference models capable of providing inferences usable to provide computer implemented services. To improve the likelihood that data processing systems have access to inference models, the system may use a data filling process to generate training datasets likely to represent real world relationships (or other types of relationships for which inferences are desired).

To generate the training datasets likely to represent real world relationships, the accuracy of the data used to fill missing values in a training dataset may be increased by using multiple imputation methods concurrently on the same dataset to generate multiple imputed datasets. The imputed datasets may be analyzed separately and may then be combined. Analysis of imputed datasets may include statistical analysis (e.g., t-tests, analysis of variance, application of descriptive statistics, etc.), modeling techniques (e.g., autoregressive integrated moving average (ARIMA), structural equation models (SEM), etc.), and/or may include other methods of analysis.

To combine the imputed datasets, a posterior distribution may be generated for each dataset after imputation and analysis. The posterior distributions for each dataset may be combined to yield a joint posterior distribution, which may include both the generated data to fill the missing values in the original dataset as well as metrics that quantify a level of confidence in the generated data.

The metrics that quantify a level of confidence in the generated data may be compared to determine the most accurate imputation method. The best-fit imputation method (e.g., linear interpolation, forward filling, etc.) may reveal the root cause for the missing data.

For example, data missing due to a power outage may be most accurately filled by a different imputation method than data missing due to a data source malfunction.

The root cause for the missing data and/or inferences provided by inferences models obtained using the resulting imputed data may then be used to provide the computer implemented services.

By doing so, a system in accordance with an embodiment may be more likely to provide desirable computer implemented services by having access to inferences that may be of higher accuracy, quality, etc. by virtue of the training data used in their construction.

To provide the above noted functionality, the system of FIG. 1 may include data cluster 100, data nodes 102, communication system 104, and downstream consumers 108. Each of these components is discussed below.

Data cluster 100 may include data nodes 102, which may store data obtained from any number of data sources. The obtained data may be incomplete. Data cluster 100 may provide data to inference model manager 106.

Inference model manager 106 may provide inference model management services. To provide inference model management services, inference model manager 106 may obtain data (e.g., from data cluster 100), process the data (e.g., fill data gaps, transform the data, extract values from the data, generate models based on the data, etc.), may provide the data to other entities (e.g., downstream consumers 108) as part of facilitating the computer-implemented services, and/or may perform other actions for managing inference models.

Downstream consumers 108 may utilize the data and/or inference models obtained by inference model manager 106 as training data for inference models. Downstream consumers 108 may use the inference models and/or other data to generate inferences and/or perform other types of actions.

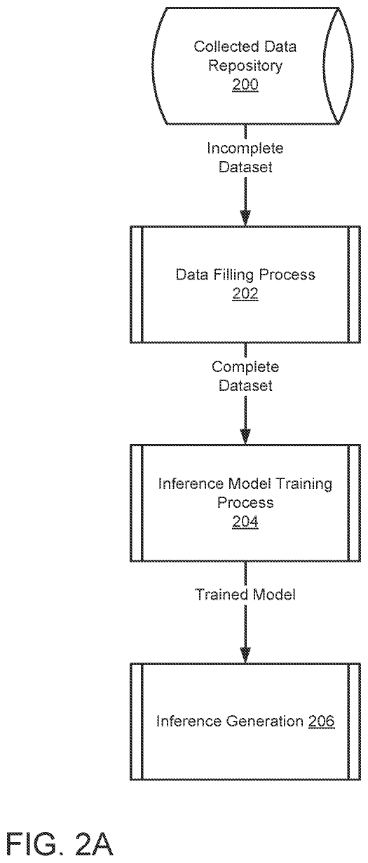

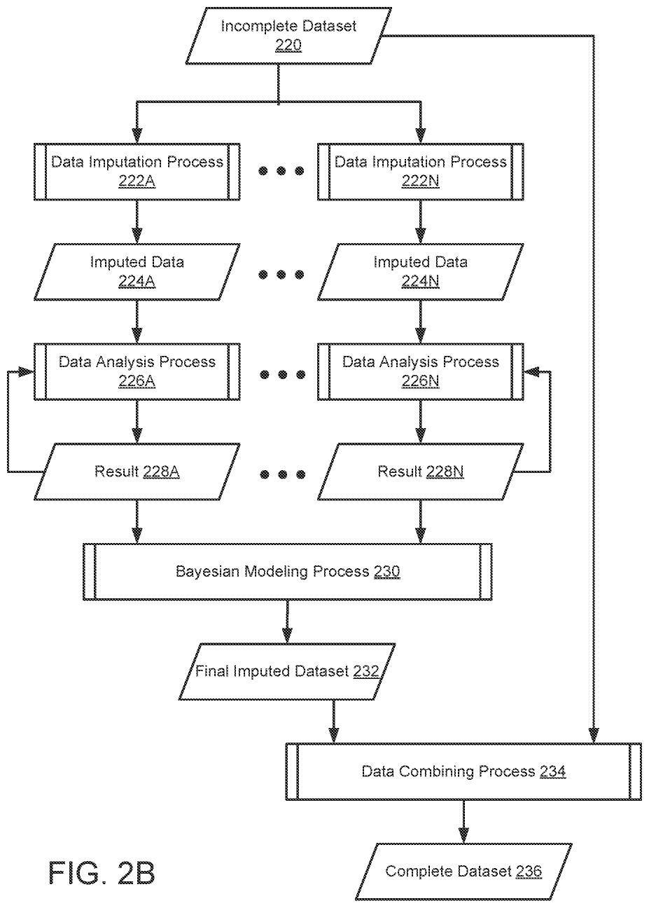

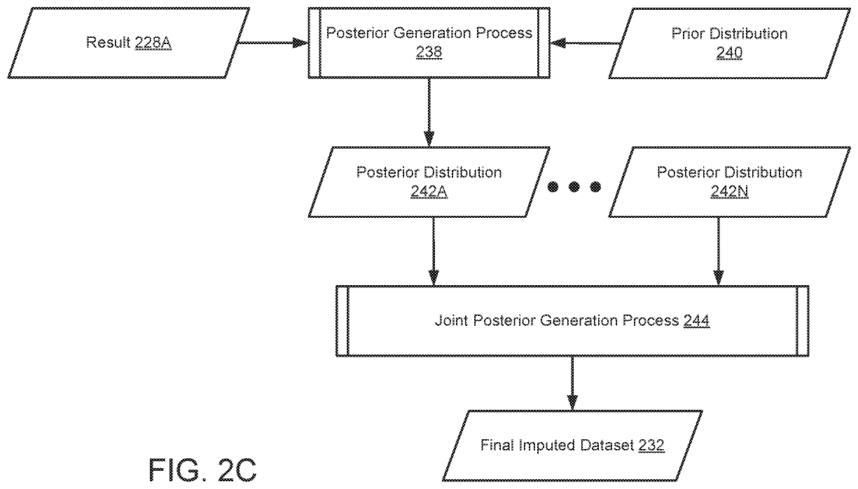

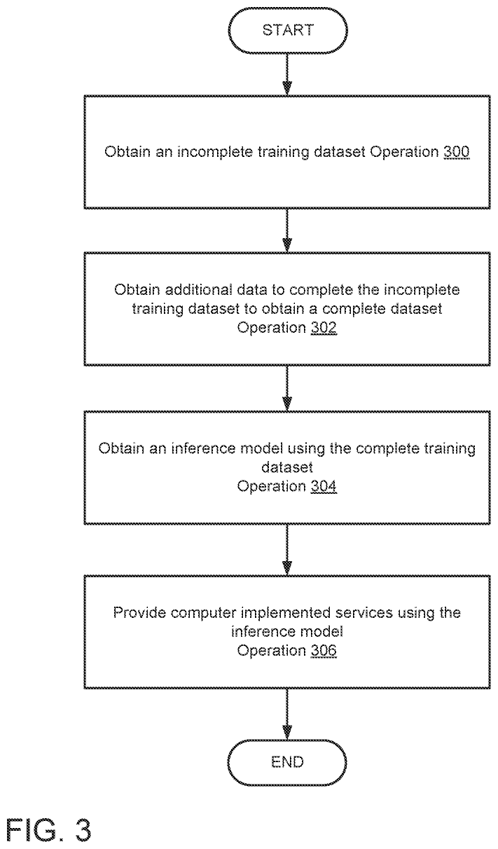

When providing their functionality, any of data cluster 100, data nodes 102, inference model manager 106, and downstream consumers 108 may perform all, or a portion, of the processes, interactions, and methods illustrated in FIGS. 2A-3.

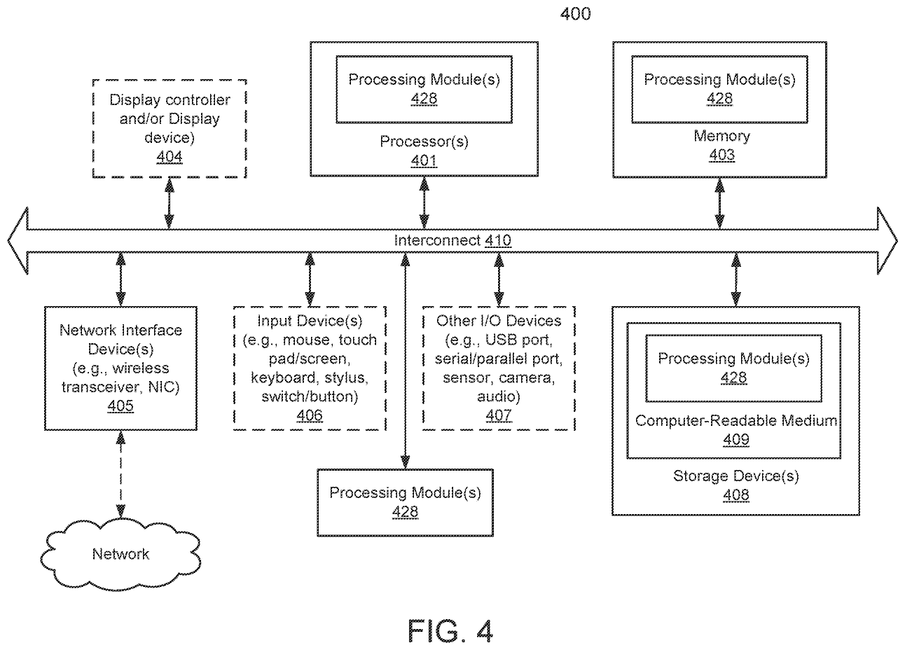

Any of data cluster 100, data nodes 102, inference model manager 106, and downstream consumers 108 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. Communication system 104 may facilitate communications between the components of FIG. 1. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 220, 224, etc.) is used to represent data structures, a second set of shapes (e.g., 202, 204, etc.) is used to represent processes performed using and/or that generate data, and a third set of shapes (e.g., 200, etc.) is used to represent large scale data structures such as databases.

Turning to FIG. 2A, a first data flow diagram in accordance with an embodiment is shown. The first data flow diagram may illustrate data used in and data processing performed in training an inference model to generate inferences.

To train an inference model to generate inferences, a complete dataset may be needed to be used as a training dataset. If inference model manager 106 shown in FIG. 1 determines a training dataset to be incomplete, data filling process 202 may be performed. During data filling process 202, an incomplete dataset from collected data repository 200 may be ingested. Once ingested, the incomplete dataset may be subjected to any number of data filling processes. Data filling processes may include using any number of data imputation methods (e.g., linear interpolation, forward filling, etc.) and/or analysis methods (e.g., statistical analysis, modeling techniques, etc.) which may result in the generation of a complete dataset. Refer to FIG. 2B for additional details regarding data filling process 202.

Once generated, inference model training process 204 may use the complete dataset as training data for an inference model to obtain a trained model. The trained model may then be used by inference generation process 206 to generate inferences.

For example, in order to generate inferences to predict future temperature conditions in various environments over time, temperature data from a temperature probe may be obtained from collected data repository 200. If the temperature data is incomplete, it may be filled by data filling process 202 to generate a complete training dataset. The inference model training process 204 may use the complete training dataset as training data for an inference model. The inference model may be trained using the training data. During the training, trends from the training data may be identified and the inference model may be adapted to generalize the trends.

To perform the training process, a model may be selected (e.g., machine learning, decision tree, linear regression, etc.) and the training data may define goals for predictions made by the model. Parameters of the model may be selected using an optimization process (e.g., an objective function may be defined in terms of the training data and predictions made by the model, and a global optimization method such as the gradient descent may be used to identify parameters that most faithfully reproduce the trends in the training data). Once the parameters of the model are set, then the model may be used to make inferences.

For example, returning to the temperature data example, the optimized model may then be used to forecast future temperatures. Because the model used to generate inferences about future temperature was optimized using the training dataset, the accuracy of the training dataset, and therefore the accuracy of the imputed data used to complete the training dataset, may impact the accuracy of the inferences.

Thus, by implementing the flow shown in FIG. 2A, a system in accordance with embodiments disclosed herein may be more likely to produce more accurate inference models by improving the accuracy of the data used to fill missing values in incomplete training datasets.

Turning to FIG. 2B, a second data flow diagram in accordance with an embodiment is shown. The second data flow diagram may illustrate data used in and data processing performed in generating a training dataset (e.g., complete data set 236). FIG. 2B may be an expansion of data filling process 202 shown in FIG. 2A.

To generate a training dataset, data imputation processes (e.g., 222A-222N) may be performed. During data imputation processes, multiple potential missing values in incomplete dataset 220 may be imputed using any number of data imputation methods (linear interpolation, forward filling, etc.). These concurrent data imputation processes may result in the generation of any number of imputed data (e.g., 224A-224N).

The imputed data may then be analyzed during data analysis processes (e.g., 226A-226N). Any of the data analysis processes may include any number of data analysis processes including, for example, statistical analysis (e.g., t-tests, analysis of variance, application of descriptive statistics, etc.), modeling techniques (e.g., autoregressive integrated moving average (ARIMA), structural equation models (SEM), etc.), and/or other methods of analysis. The data analysis processes may generate any number of corresponding results (e.g., 228A-228N). After data analysis processes, the results may be reanalyzed by data analysis process 226 to yield a new or additional result.

For example, data analysis process 226A may fit an ARIMA model to imputed data 224A to generate result 228A. Result 228A may then be used as input data to fit a linear regression model in data analysis process 226B which may generate result 228B. The aforementioned process may, when results indicating that corresponding imputed data is inaccurate, be repeated using different analysis processes to ascertain whether multiple analysis processes agree or disagree with the initial analysis. A consistent view regarding acceptability of the imputed data may be obtained in this manner and used as the basis for subsequent operations.

This method of using multiple data imputation and analysis processes may result in the generation of any number of results. The results may then be combined during Bayesian modeling process 230 to generate final imputed dataset 232. Final imputed dataset 232 may include both the final imputed data as well as metrics that quantify a level of confidence in the imputed data. Refer to FIG. 2C for additional details regarding Bayesian modeling process 230.

Final imputed dataset 232 may then be combined with incomplete dataset 220 using data combining process 234. Data combining process 234 may use the imputed data in final imputed dataset 232 to fill the missing values in incomplete dataset 220 to generate complete dataset 236. Complete dataset 236 may then be used as a training dataset to train inference models using inference model training process 204 shown in FIG. 2A.

Thus, via the processes illustrated in FIG. 2B, a system in accordance with an embodiment may generate a training dataset from an incomplete dataset using multiple data imputation methods. The use of multiple data imputation methods may result in more accurate imputed data, which may improve the accuracy of the training dataset and therefore the inferences generated by an inference model trained on the training dataset.

Turning to FIG. 2C, a third data flow diagram in accordance with an embodiment is shown. The third data flow diagram may illustrate data used in and data processing performed in combining multiple imputed datasets to generate final imputed dataset 232. FIG. 2C may be an expansion of Bayesian modeling process 230 shown in FIG. 2B.

To combine multiple imputed datasets to generate final imputed dataset 232, posterior generation process 238 may be performed. During posterior generation process 238, the imputed and analyzed datasets (e.g., result 228A), may be combined with prior distribution 240 to generate a posterior distribution (e.g., 242A). Posterior generation process 238 may be repeated for each result to generate any number of posterior distributions (e.g., 242A-242N).

Once generated, the posterior distributions may be combined during joint posterior generation process 244 to produce final imputed dataset 232. Final imputed dataset 232 may then be combined with incomplete dataset 220 during data combining process 234 shown in FIG. 2B.

Thus, via the processes illustrated in FIG. 2C, a system in accordance with an embodiment may combine multiple imputed datasets using a Bayesian modeling approach. A Bayesian approach may allow for both the generation of a combined dataset based on multiple imputation methods as well as metrics that quantify a level of confidence in the imputed data. A quantification of uncertainty in the data may result in the ability to evaluate the validity of the imputed data.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide computer implemented services using inference models. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer implemented services using inference models in accordance with an embodiment is shown. The method may be performed, for example, by any of the components of the system of FIG. 1, and/or other components not shown therein.

At operation 300, an incomplete training dataset may be obtained. The incomplete training dataset may be obtained by (i) reading the incomplete training dataset from storage, (ii) generating the incomplete training dataset based on measurements or other information, (iii) receiving the incomplete training dataset from another device, and/or via other methods.

At operation 302, additional data to complete the incomplete training dataset may be obtained to obtain a complete training dataset. The additional data may be obtained by (i) reading the additional data from storage, (ii) generating the additional data, (iii) receiving the additional data from another device, and/or via other methods.

The additional data may be generated by (i) obtaining a plurality of imputation results using the imputation algorithms, (ii) analyzing the plurality of imputation results to obtain a plurality of analysis results that are usable to guide a synthesis process through which the additional data is obtained using the plurality of imputation results, and (iii) using the plurality of analysis results and the plurality of imputation results to obtain the additional data.

The plurality of imputation results may be obtained by using the incomplete training dataset as input for an imputation algorithm of the imputation algorithms to obtain output from the imputation algorithm. The output may be one of the imputation results, and any number of imputation results may be obtained using any number of imputation algorithms.

The plurality of imputation results may be analyzed by applying an analysis algorithm to an imputation result of the imputation results to obtain a metric that quantifies a quality of the imputation result. The metric may be the output of one of the analysis algorithms, and any number of metrics may be obtained using any number of analysis algorithms.

The plurality of analysis results and the plurality of imputation results may be used to obtain the additional data by combining the plurality of analysis results to obtain a joint result. The joint result may include (i) the additional data and (ii) metrics that quantify a level of confidence in the additional data.

The plurality of analysis results may be combined to obtain a joint result by using the analysis results to weight the plurality of imputation results, and using the weights to obtain the joint result. The plurality of analysis results may be used as part of a Bayesian analysis procedure to obtain the joint results.

At operation 304, an inference model may be obtained using the complete training dataset. The inference model may be obtained by (i) reading the inference model from storage, (ii) generating the inference model, (iii) receiving the inference model from another device, and/or via other methods.

The inference model may be generated by training the inference model on the complete training dataset.

At operation 306, computer implemented services may be provided using the inference model. The computer implemented services may be provided by (i) using the inference model to generate inferences, (ii) providing the inference model to an inference model consumer, and/or via other methods.

The method may end following operation 306.

In addition to operations 300-306, the method may include identifying an inference model of a plurality of inference models used to obtain the additional data that was deemed to most accurately infer the additional data. The inference model may be identified by comparing metrics associated with the fit of each inference model.

In addition to operations 300-306, the method may include, based on the identified inference model, identifying a root cause for the incomplete training data set to exist. The root cause may be identified by analyzing metrics obtained during the process of obtaining the additional data, imputation models used in obtaining the additional data may be ranked based on ascribed levels of accuracy, etc. For example, root causes may be associated with different imputation models, and the root cause associated with the imputation model ascribed the highest level of accuracy may be identified as the root cause for the incomplete training data.

Thus, using the methods illustrated in FIG. 3, embodiments disclosed herein may increase the likelihood of generating inference models capable of providing computer implemented services by improving the quality of training datasets used to train the inference models.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing inference models, the method comprising:
obtaining an incomplete training dataset;
obtaining additional data to complete the incomplete training dataset to obtain a complete training dataset;
obtaining an inference model using the complete training dataset; and
providing computer implemented services using the inference model.

2. The method of claim 1, wherein the additional data is obtained using a plurality of imputation algorithms.

3. The method of claim 2, wherein obtaining the additional data comprises:
obtaining a plurality of imputation results using the imputation algorithms;
analyzing the plurality of imputation results to obtain a plurality of analysis results that are usable to guide a synthesis process through which the additional data is obtained using the plurality of imputation results; and
using the plurality of analysis results and the plurality of imputation results to obtain the additional data.

4. The method of claim 3, wherein using the plurality of analysis results and the plurality of imputation results comprises:
combining the plurality of analysis results to obtain a joint result, and the joint result comprising:
the additional data; and
metrics that quantify a level of confidence in the additional data.

5. The method of claim 1, further comprising:
identifying an inference model of a plurality of inference models used to obtain the additional data that was deemed to most accurately infer the additional data; and
identifying, based on the identified inference model, a root cause for the incomplete training data set to exist.

6. The method of claim 5, wherein the root cause is used, in part, to the provide the computer implemented services.

7. The method of claim 1, wherein the incomplete training dataset specifies a portion of a relationship, the additional data specifies a second portion of the relationship, and the complete training data specifies an entirety of the relationship.

8. The method of claim 7, wherein the inference model is trained to forecast the relationship outside of the domain defined by the complete training data.

9. A non-transitory machine-readable medium having instructions stored therein, which when executed by a processor, cause a device to perform operations for managing inference models, the operations comprising:
obtaining an incomplete training dataset;
obtaining additional data to complete the incomplete training dataset to obtain a complete training dataset;
obtaining an inference model using the complete training dataset; and
providing computer implemented services using the inference model.

10. The non-transitory machine-readable medium of claim 9, wherein the additional data is obtained using a plurality of imputation algorithms.

11. The non-transitory machine-readable medium of claim 10, wherein obtaining the additional data comprises:
obtaining a plurality of imputation results using the imputation algorithms;
analyzing the plurality of imputation results to obtain a plurality of analysis results that are usable to guide a synthesis process through which the additional data is obtained using the plurality of imputation results; and
using the plurality of analysis results and the plurality of imputation results to obtain the additional data.

12. The non-transitory machine-readable medium of claim 11, wherein using the plurality of analysis results and the plurality of imputation results comprises:
combining the plurality of analysis results to obtain a joint result, and the joint result comprising:
the additional data; and
metrics that quantify a level of confidence in the additional data.

13. The non-transitory machine-readable medium of claim 9, where the operations further comprise:
identifying an inference model of a plurality of inference models used to obtain the additional data that was deemed to most accurately infer the additional data; and
identifying, based on the identified inference model, a root cause for the incomplete training data set to exist.

14. The non-transitory machine-readable medium of claim 13, wherein the root cause is used, in part, to the provide the computer implemented services.

15. The non-transitory machine-readable medium of claim 9, wherein the incomplete training data set specifies a portion of a relationship, the additional data specifies a second portion of the relationship, and the complete training data specifies an entirety of the relationship.

16. The non-transitory machine-readable medium of claim 15, wherein the inference model is trained to forecast the relationship outside of the domain defined by the complete training data.

17. A data processing system, comprising:
a memory; and
a processor coupled to the memory that store instructions, which when executed by the processor, cause the processor to perform operations for managing inference models, the operations comprising:
obtaining an incomplete training dataset;
obtaining additional data to complete the incomplete training dataset to obtain a complete training dataset;
obtaining an inference model using the complete training dataset; and
providing computer implemented services using the inference model.

18. The data processing system of claim 17, wherein the additional data is obtained using a plurality of imputation algorithms.

19. The data processing system of claim 18, wherein obtaining the additional data comprises:
obtaining a plurality of imputation results using the imputation algorithms;
analyzing the plurality of imputation results to obtain a plurality of analysis results that are usable to guide a synthesis process through which the additional data is obtained using the plurality of imputation results; and
using the plurality of analysis results and the plurality of imputation results to obtain the additional data.

20. The data processing system of claim 19, wherein using the plurality of analysis results and the plurality of imputation results comprises:
combining the plurality of analysis results to obtain a joint result, and the joint result comprising:
the additional data; and
metrics that quantify a level of confidence in the additional data.
